(19) United States
(12) Patent Application Publication
(10) Pub. No.: US 2017/0259384 A1
(43) Pub. Date: Sep. 14, 2017

(54) SYSTEM AND METHOD FOR ROBOTIC THERMAL TREATMENT BY HEAT INDUCTION

(71) Applicant: HYDRO-QUEBEC, Montreal, Quebec (CA)

(72) Inventors: Eric BOUDREAULT, LaPrairie, Quevec (CA); Bruce HAZEL, Montreal, Quebec (CA); Jacques LANTEIGNE, Longueuil, Quebec (CA); Jean COTE, Saint-Mathieu-de-Beloeil, Quebec (CA); Marin LAGACE, Saint-Bruno-de-Montarville, Quebec (CA); Mathieu GENDRON, Longueuil, Quebec (CA)

(73) Assignee: HYDRO-QUEBEC, Montreal, Quebec (CA)

(21) Appl. No.: 15/329,945

(22) PCT Filed: Jul. 29, 2014
(86) PCT No.: PCT/CA2014/050715

§ 371 Date: Jan. 27, 2017

(51) Int. Cl. B23P 6/04; H05B 6/06; H05B 6/10; B23K 31/02; C21D 1/42; C21D 9/50; C21D 6/00; C22C 38/40; B25J 11/00; H05B 6/40

(52) U.S. Cl. CPC B23P 6/045; B25J 11/00; H05B 6/06; H05B 6/101; H05B 6/40; C21D 1/42; C21D 9/50; C21D 6/004; C22C 38/40; B23K 31/02; C21D 2211/008; B23K 2201/001

(57) ABSTRACT

Method and system for thermal treatment by heat induction of a metal piece on a targeted zone. According to the method, the thermal treatment is carried out using a thermal element mounted on a robotic system for moving the thermal element along a cyclical trajectory on the targeted zone so as to heat the target zone and minimize the temperature deviations over the targeted zone.

### FIELD OF THE INVENTION

The present invention relates to a system and method of repair by thermal treatment of a damaged metal piece.

### BACKGROUND OF THE INVENTION

More than one third of the hydropower plants of Hydro-Québec consists of turbine wheels made of martensitic stainless steel 13Cr-4Ni (CA6NM). The wheels are aging and cracks resulting from fatigue loading appear in several facilities. For metallurgical reasons, repairs are so far carried out with austenitic 309L steel. The yield strength of this steel is half that of the base material. The resistance to cavitation is greatly reduced. The use of different steel to correct defects causes a microstructural heterogeneity in the heat affected zone (HAZ). The problem is even aggravated as the properties of the base material around the area where the crack has spread have not been able to withstand the passage of time. In summary, the weakening of the wheel due to the current repair process generates a recurring problem.

To restore the mechanical properties and reduce the internal stresses induced during welding with a homogeneous wire, manufacturers place, once the wheel is completed, the entire piece in a furnace of very large size. The piece is then heated and maintained at a temperature of about 600° C. for several hours. The difficulty of making such an effective thermal treatment in situ was impeded, until now, by the use of a homogeneous wire (410NiMo).

Thus, given the current technical difficulties, there is therefore a need in the art for in situ thermal treatment of a damaged metal piece, such as a cracked water wheel, without having to transport it to very large furnaces.

Turbine Wheel Repair

The equipment used by the hydropower industry are generally very large. Components such as turbine wheels are assembled from simple castings and machined pieces. These pieces are then welded together to generate the wheel. As mentioned above, the welding operation greatly deteriorates the properties of several steels and generates high internal stresses. To ensure the quality of the assembly, the manufacturer prefers to place the new piece in an oven. There is therefore, in this field, a need for a reliable method for carrying out such a thermal treatment on massive pieces having a complex geometry.

As shown in FIG. 2, the situations in which a thermal treatment after repair is desirable are: cracks, damages caused by cavitation and damages caused by erosion.

### OBJECT OF THE INVENTION

An object of the present invention is to provide a method for induction thermal treatment on a targeted zone of a metal piece, the method comprising: performing the thermal treatment on the targeted zone using a thermal element mounted on a robotic system for displacing the thermal element by following a cyclical trajectory on the targeted zone so as to heat the targeted zone and to minimize temperature deviations on the targeted zone.

Another object of the present invention is to provide a system for thermal treatment on a targeted zone of a metal piece, comprising a thermal element mounted on a robotic system for displacing the thermal element by following a cyclical trajectory on the targeted zone so as to heat the targeted zone and to minimize temperature deviations on the targeted zone.

Advantageously, according to a preferred aspect of the present invention, the robotic induction heating technology achieves localized thermal treatments on pieces having large dimensions, by means of a compact system. The local temperature profile is controlled using an induction heating source moved in a cyclical trajectory by means of a compact manipulator.

Advantageously, in addition to the induction heating system installed on a robot, a measuring system may be used to ensure the quality of the temperature profile and controlling the parameters that influence the uniformity of the temperature. A simulator may be used to predict the temperature profile that will be generated by the movement of the induction heating source. By means of the simulator, an algorithm determines the parameters of the trajectory of the robot that will generate locally the most uniform temperature possible. To ensure the flexibility of the process, the simulations must be achievable in situ. To do this, the calculations are performed on high performance computing systems.

Advantageously, the robotic heating method is performed by assembling seven different technologies. As mentioned previously, the local temperature profile is controlled by using an induction heating source moved in a cyclical trajectory by means of a compact manipulator. In addition to the induction heating system installed on a robot, a measuring system may be used to ensure the quality of the temperature profile and to compensate for modelling errors. A simulator may be used to predict the temperature profile to be generated. By means of the simulator, an algorithm determines the parameters of the trajectory of the robot that will generate locally the most uniform temperature possible. To ensure the flexibility of the process, the simulations are performed on high performance computing systems. The ultimate goal is to achieve the thermal treatment as short as possible. The optimization of space-time temperature profile may limit the time of intervention in relation to thermal treatments that are traditionally used in the industry.

Other objects, features and advantages of the present invention will become more apparent in view of the following description of possible embodiments, given by way of example only, in relation to the following figures.

### BRIEF DESCRIPTION OF FIGURES

FIGS. 1a) to 1f) is a schematic diagram showing the repair steps of a crack in a piece of metal, according to a preferred embodiment of the invention.

FIG. 2 is a perspective view of a known hydraulic turbine illustrating situations in which a thermal treatment after repair is desirable, i.e. cracks, damage caused by cavitation and damage caused by erosion.

FIG. 3 is a schematic view of the various technologies that may be used in the present invention.

FIG. 4 is a perspective view of a thermal processing system of a crack, including a robot that is about to heat a welded zone, according to a preferred embodiment of the invention.

FIG. 5 is a diagram of an electronic circuit illustrating a thermal induction heating system, according to a preferred embodiment of the present invention.

FIG. 6 is a perspective view of a serpentine coil or induction coil, according to a preferred embodiment of the present invention.

FIG. 7 is a perspective view of a serpentine coil or induction coil with a flux concentrator, according to a preferred embodiment of the present invention.

FIG. 8 is a perspective view of a thermal treatment system using a finite element simulator by induction heating, according to a preferred embodiment of the present invention.

FIG. 9a is a schematic view of a simulation of a real heat flux by unit area input of the serpentine coil or thermal element that is injected on a cyclic trajectory, according to a preferred embodiment of the present invention.

FIG. 9b is a schematic view of a simulation of a heat flux per unit effective area input of the heated zone on the cyclic trajectory shown in FIG. 9a.

FIGS. 10a) and 10b) is a diagrammatic view showing a comparison between the real temperature profile and that generated by the mean source, on a rectilinear cyclic trajectory.

FIGS. 11a) to 11c) is a schematic view showing three possibilities or examples of cyclic trajectories of a serpentine coil or thermal source above a zone to be heated.

FIG. 12 is a schematic view showing the composition of a cyclic trajectory, according to a preferred embodiment of the present invention.

FIG. 13 is a schematic view showing a fast cyclic trajectory moving along a slow trajectory, according to a preferred embodiment of the present invention.

FIG. 14a is a schematic view of a mesh of a complex piece, according to a preferred embodiment of the present invention.

FIG. 14b is a schematic view of a parametric curvilinear coordinate system attached to the meshing surface of FIG. 14a.

FIG. 14c is a schematic view of a parametric surface coordinate system of FIG. 14b in the parametric reference frame.

FIGS. 15a) to 15d) show perspective views of the displacement of the heating system on a curved geometry, according to a preferred embodiment of the present invention.

FIG. 16 is a schematic view of the calculation steps of the ideal trajectory parameters, according to a preferred embodiment of the present invention.

FIGS. 17a), 17b), 17c) and 17d) show schematic views of four steps of a nonlinear optimization algorithm, which improves the steady state parameters, according to a preferred embodiment of the present invention.

FIGS. 18a) and 18b) show graphs showing the influence of inner and outer radii of the source on the temperature profile.

FIG. 19 shows graphs illustrating the influence of the distance e between the outbound and the return on the temperature profile.

FIG. 20 shows graphs shoving the influence of the modulation of heat flux as a function of position on the temperature profile.

FIG. 21 is a graph showing the modulation of heat flux versus time.

FIGS. 22a) and 22b) show graphs illustrating the power modulation as a function of position on the fast path.

FIGS. 23a) and 23b) show graphs illustrating the power modulation as a function of position on the slow path.

FIG. 24 is a graph showing the power modulation as a function of position on the composite parametric surface.

FIGS. 25a) and 25b) show schematic views of the infrared reading of the temperature profile by an infrared camera.

FIG. 26 is a perspective view of a UNS S41500 steel plate used for validating the system.

FIGS. 27a) and 27b) show graphs of the mechanical properties of the plate of FIG. 26 that has been heat treated according to a preferred method of the present invention.

FIG. 28 shows a schematic diagram illustrating the internal stresses after welding and after the thermal treatment, according to a preferred method of treatment of the present invention.

### DESCRIPTION OF EMBODIMENTS OF THE INVENTION

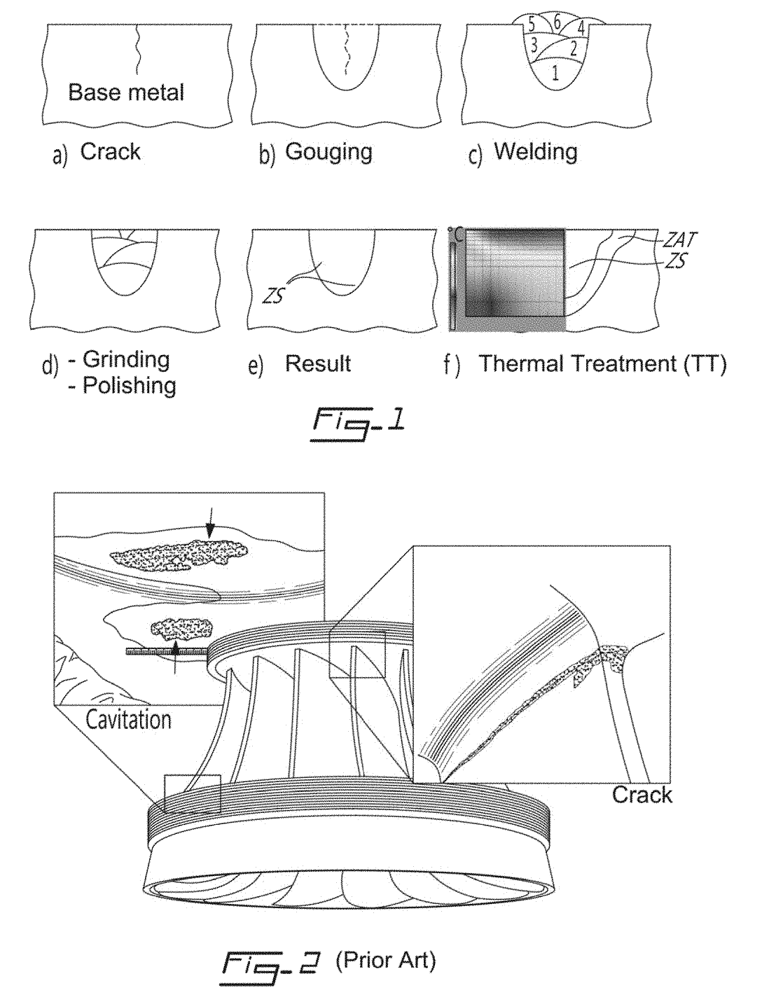

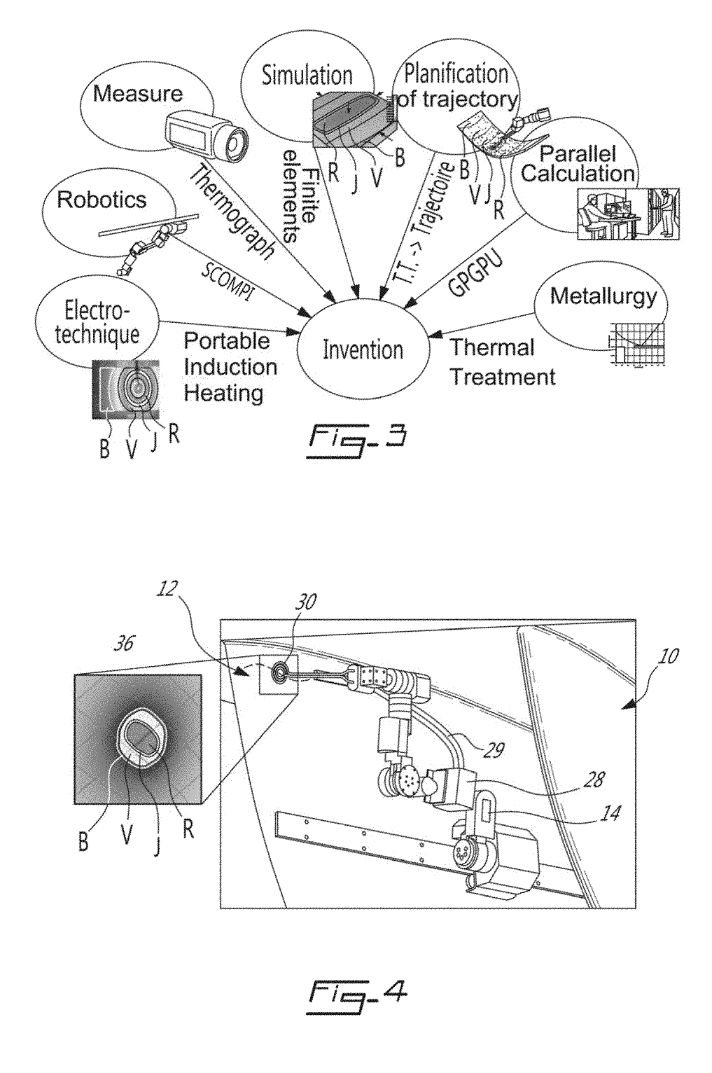

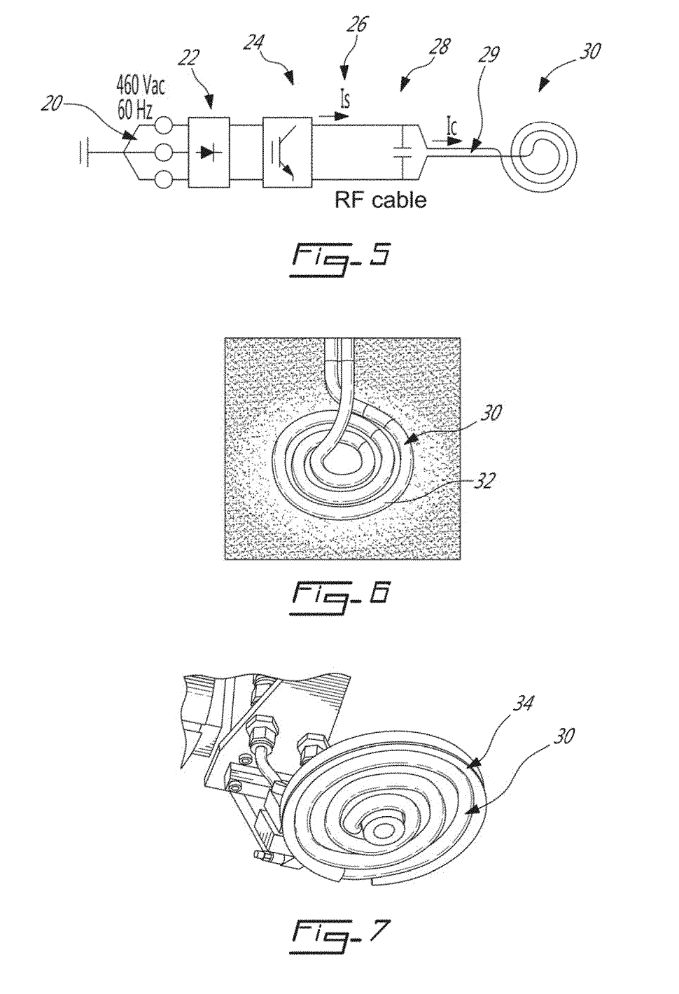

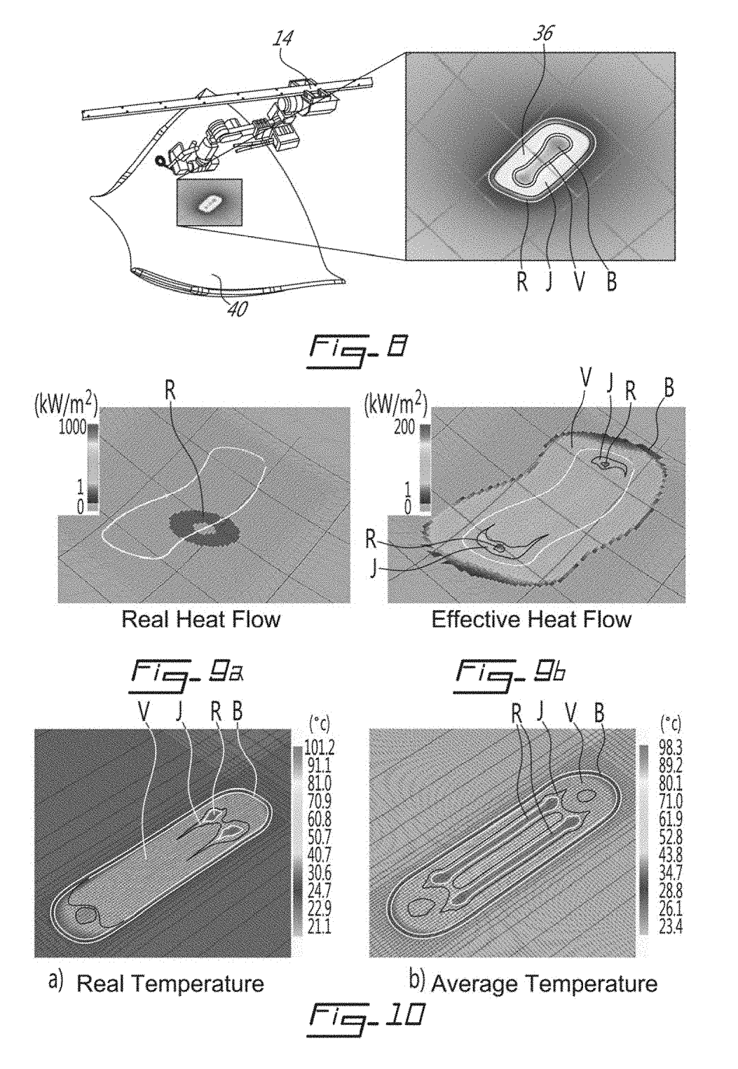

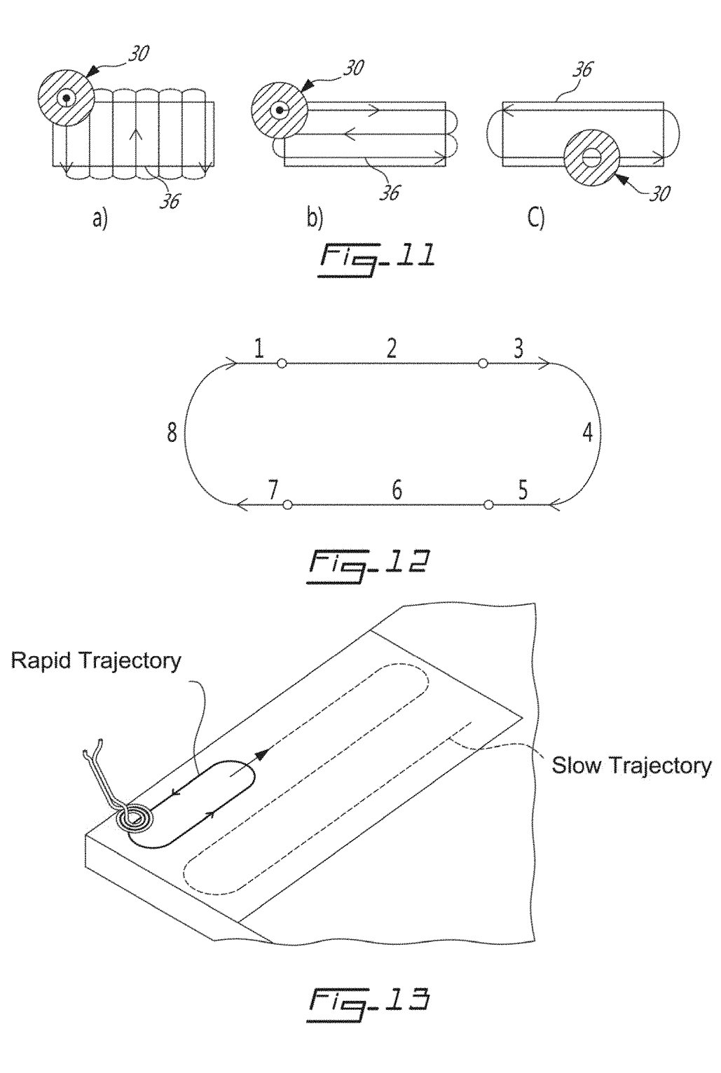

Referring to FIG. 1, there is illustrated the steps of repair of a crack in a base piece of metal, according to a preferred embodiment of the present invention. The repair comprises the following steps of: a) detecting a crack; b) performing a gouging and/or machining around the crack; c) welding after the gouging and/or machining; d) grinding and/or polishing after the welding; e) inspecting the result of the welded zone (ZS); f) performing a thermal treatment of the welded zone (ZS) that extends to a heat affected zone (ZAT) if necessary. A thermal treatment (TT) may be performed manually using a heater or a torch. However, the inventors have found that it is extremely difficult, if not impossible, to maintain a relatively uniform heating temperature across the entire surface of the welded zone (ZS) manually.

Referring to FIG. 4, a robotic system 10 is shown for the thermal treatment of a weld zone 12, according to a preferred embodiment of the invention. The system includes a robot 14, which is set to heat the welded zone 12 using a thermal element. Preferably, the thermal element comprises a serpentine coil or induction coil 30.

The advantages of induction heating are that it is non-contact, smokeless, safe in isolation and easy to control.

Electronics

In order to ensure the movement of the power source with a mobile manipulator robot 14 shown in. FIG. 4 and to enable use in tight spaces, a portable electronic was developed. To do this, and with reference also to FIG. 5, the power source 20 with the rectifier 22 and inverter 24, capacitor 28 and the induction coil 30 are separated and embedded within a parallel resonant circuit. A circuit diagram is shown in FIG. 5. In the low-current section I_{S}, a RF cable 26 separates the inverter 24 from the capacitors 28. In the high-current zone I_{C}, a flexible and braided conductor 29 separates the coil 30 from the capacitors 28.

Serpentine Coil

Referring to FIG. 6, there is shown a serpentine coil or induction coil 30 that may be made by means of an insulated copper tube 32. A serpentine coil of small size is used to ensure the displacement of the inductor in complex trajectories for shapes having medium and high curvatures. The flexibility obtained by the displacement of a substantially circular coil of small size allows to heat an infinite number of geometries (see trajectory planning section).

Flux Concentrator

Referring to FIG. 7, to improve the efficiency of the system, a flux concentrator 34 is added on the outer surfaces of the coil 30. This concentrator 34 allows for the same current flawing through the coil to generate more magnetic flux.

Mobile Robot

The serpentine coil 30 is installed to the end-effector of a portable manipulator. For achieving the method, the Scompi™ manipulator or robot 14 shown in FIG. 4 is used. This robot 14 is designed to fit into the limited space available between the Francis turbine blades. This robot 14 can also be used for laser measurement operations, gouging, welding, grinding, polishing, cutting and hammering which usually precedes the thermal treatment.

Thermal Simulator

Referring to FIG. 8, there is shown a thermal treatment system including the robot 14 using a simulator simulating the finite elements of the induction heating. A finite element simulation software has been developed for calculating from an induction heating source the temperature profile resulting in a heated zone of a piece 40.

Modelling of Heating Source

Several trials have concluded that for a local curvature of the piece and of the same source, the heating source used in the calculation by finite elements can be modeled using a heat flux per unit area (W/m2) also distributed within an annular geometry. The ring dimensions are generally similar to those of the inductor. An example of the heat flux distribution per unit area used is shown in FIG. 9a.

Finite Elements

In order to quickly resolve the intrinsic heat equation finite differences method (see [1]) we use the Crank-Nicolson trapezoidal integration. The thermal properties of the material are assumed constant within the same time step. That is

$$( \frac{1}{Δ t} [ C ( {T}_{n + 1} ) ] + β [ K ( {T}_{n + 1} ) ] ) {\{ T \}}_{n + 1} = ( \frac{1}{Δ t} [ C ( {T}_{n} ) ] - ( 1 - β ) [ K ( {T}_{n} ) ] ) {\{ T \}}_{n} + ( 1 - β ) {\{ R ( {T}_{n} ) \}}_{n} + β {\{ R ( {T}_{n + 1} ) \}}_{n + 1} \qquad ( 1 )$$

becomes:

$$( \frac{1}{Δ t} [ C ( {T}_{n} ) ] + β [ K ( {T}_{n} ) ] ) {\{ T \}}_{n + 1} = ( \frac{1}{Δ t} [ C ( {T}_{n} ) ] - ( 1 - β ) [ K ( {T}_{n} ) ] ) {\{ T \}}_{n} + ( 1 - β ) {\{ R ( {T}_{n} ) \}}_{n} + β {\{ R ( {T}_{n} ) \}}_{n + 1} \qquad ( 2 )$$

We also linearize by calculating the emissivity factor h_{rad} presented in equation (3) assuming that the temperature Tₙ₊₁ is identical to the previous time Tₙ.

hₙₓₜ=εσ(Tₙ₊₁²+Tₙ²)(Tₙ₊₁+T_{fl})≈εσ(Tₙ²+T_{fl}²)(Tₙ+T_{fl}) (3)

where ε is the emissivity, and σ the Stefan-Boltzmann constant.

Average Temperature

As shown in trajectory planning section, the source is moved cyclically on the surface. The back and forth mode movement generates local and cyclic temperature variations. The longer the delay between when the source passes over a coordinate and comes back, the greater the temperature variation is large. The simulator estimates the effective temperature among these temperature variations. This temperature is the constant value that produces the same effect on the mechanical properties of the material as the intrinsic temperature variations robotic thermal treatment process.

In order to obtain the effective temperature, the software uses an average source. The software therefore calculates the total energy injected locally (in each element) on the same cycle. This energy is then divided by the total time (t_{cycle}) that it takes the source to complete the cycle. FIG. 9 shows the heat flow per unit area (W/m2) versus the one that is modeled. Equation (4) determines fᵢ(x, y, z) that is the average heat flux per unit area injected into the element i on a cycle. The first term is the heat flow per actual unit area that is injected by the source in the material. The second term is the amount of time it takes the source to complete a cycle (t_{cycle}) that the source passes to heat a coordinate (tᵢ(x, y, z)).

$${f}_{i} ( x , y , z ) = \frac{Q}{A} \frac{{t}_{i} ( x , y , z )}{{t}_{cycle}} \qquad ( 4 )$$

where Q is the heat flux from the source and A is he area of the projected source on the surface.

The effective source covers the entire area swept by the serpentine coil. It injects into each of the elements the average heat flow created within a scanning cycle. In addition to calculating the average temperature in the plate, this strategy reduces by several orders of magnitude the calculation time. FIG. 10 shows a comparison between the real temperature profile and the average one generated by the source, and on a rectilinear and cyclic trajectory.

It should be noted that the formula (4) above assumes a uniform distribution of heat flow in the inductor and is a refinement of the more general formula:

$${f}_{i} ( x , y , z ) = \frac{{\int }_{0}^{{t}_{cycle}} {f}_{i} ( x , y , z , t ) dt}{{t}_{cycle}}$$

As understood by those skilled in the field, other types of models or formulas may be used to achieve similar results.

Trajectory Planning

Cyclic Trajectory (fast)

The manipulator or robot 14 moves the source or serpentine coil 30 cyclically over a target area 36 (shaded in FIG. 11) to cause and control the heating. FIG. 11 shows three possible trajectories. As presented in the previous section, the displacement of the source 30 in a cyclical manner generates local temperature variations. The chosen solution, c) in FIG. 11 is the one which minimizes the time between the outbound and return and therefore the temperature variations measured locally on the same cycle.

Referring to FIG. 12, the cyclic trajectory is divided into 8 sections. Sections 1, 3, 5 and 7 are the acceleration and deceleration zones. The sections 2 and 6 are the zones of constant speed movement. The zones 4 and 8 are sections that attach the two groups formed of sections 1, 2 and 3 with 5, 6 and 7. For zones 4 and 8 both the length of turning and the maximum acceleration can be specified.

Sections 1, 2, 3, 5, 6, 7 are shown linearly to simplify understanding. In practice, these sections are usually curves.

Slow Trajectory

As shown in FIG. 13, the fast cyclic trajectory (tᵣₐₚ) is moved on a slow trajectory (tₗₑₙₜ). This combination allows to treat a volume having an outer surface that may be of all possible sizes and geometries. The parameters of the quick path can be changed depending on the position on the slow path to account for the heat treatment needs.

Complex Geometry

The trajectory shown in FIG. 13 heats a rectangular zone on a flat surface. Many applications, however, require to handle complex areas on curved surfaces.

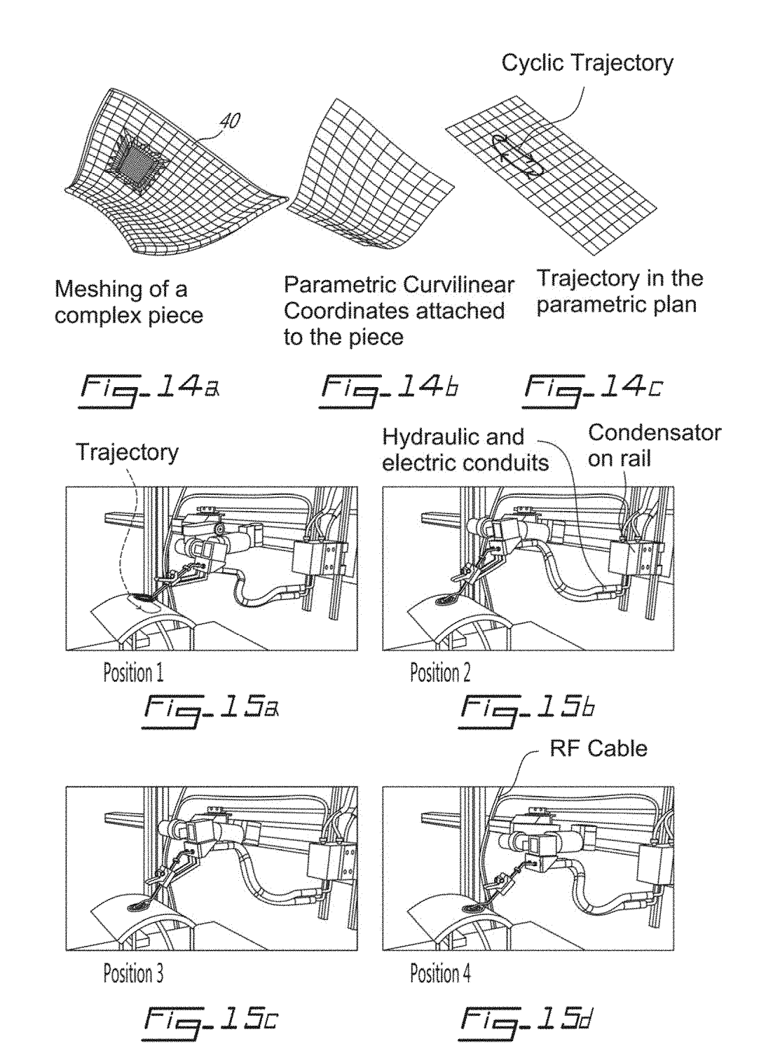

As shown in FIG. 14a), in order to allow the use of the finite elements simulator, the piece 40 is first three-dimensionally meshed. Then, a secondary curvilinear mesh n×m surface called work area is attached to a surface of the three-dimensional mesh. FIG. 14b) shows the composite surface n×m called work area. The surface mesh is then projected in a coordinate system (u, v, w) to obtain a composite parametric surface with a regular mesh as shown in FIG. 14c).

The geometry of the area to be heated in a Cartesian world is then deformed in the parameter space. The cyclic trajectory used to heat this zone is generally produced in this space. At this stage the parametric distance between the outbound and return trajectory (straight lines in FIG. 12) is constant. This trajectory is then adjusted to ensure that the actual geodesic distance (shortest distance measured along the surface) between the outbound and the return of the source is equal to the distance required. Other types of cyclic trajectories may also be obtained. FIG. 15 shows the displacement of the heating system on a curved geometry.

Step Planning Heating Settings

FIG. 16 summarizes the steps of calculation. Initially (FIG. 16), the system uniformizes, around the zone to be heated, the temperature profile (T) at steady state. This optimization is used to generate the shape of the cyclic trajectory (e.g. FIG. 14c), which will be used during each phase of the thermal treatment. The relative heat flow is then modulated as a function of time and position of the source on the same trajectory. The details of the heat flow of the modulation process are presented in the Productivity of the longitudinal temperature profile section. This modulation generates a uniform profile as well as when the temperature rises than during the temperature maintenance phase (thermal treatment). The nominal flow of heat is finally adjusted to meet the required thermal treatment (TT) (e.g. between 630 and 600° C. for 1 hour).

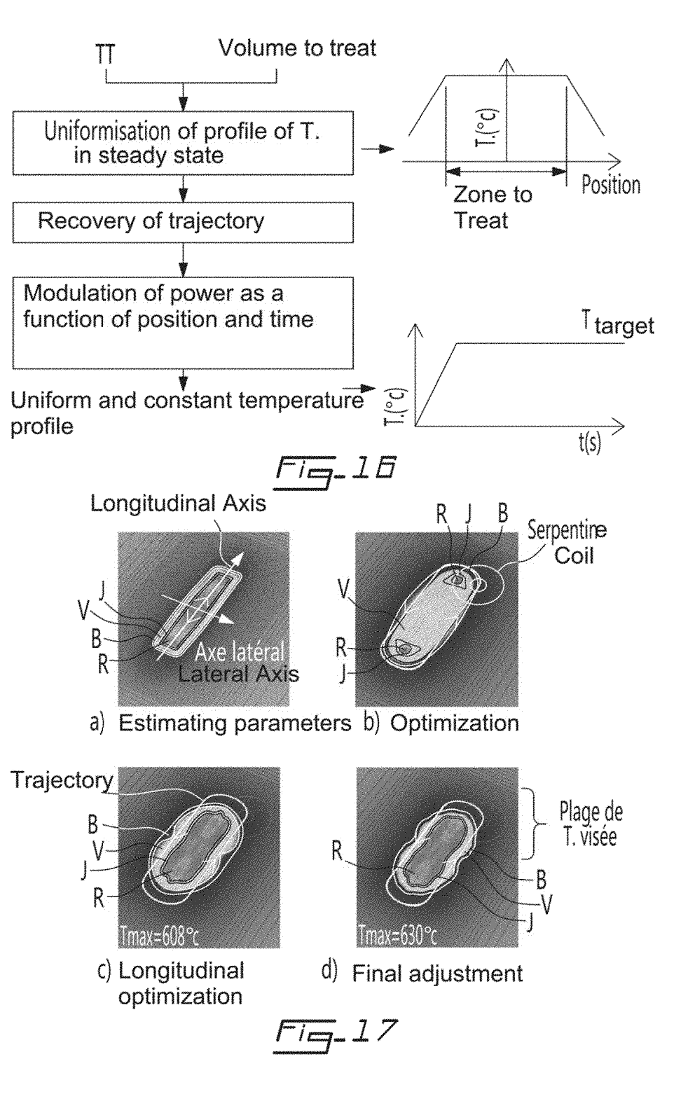

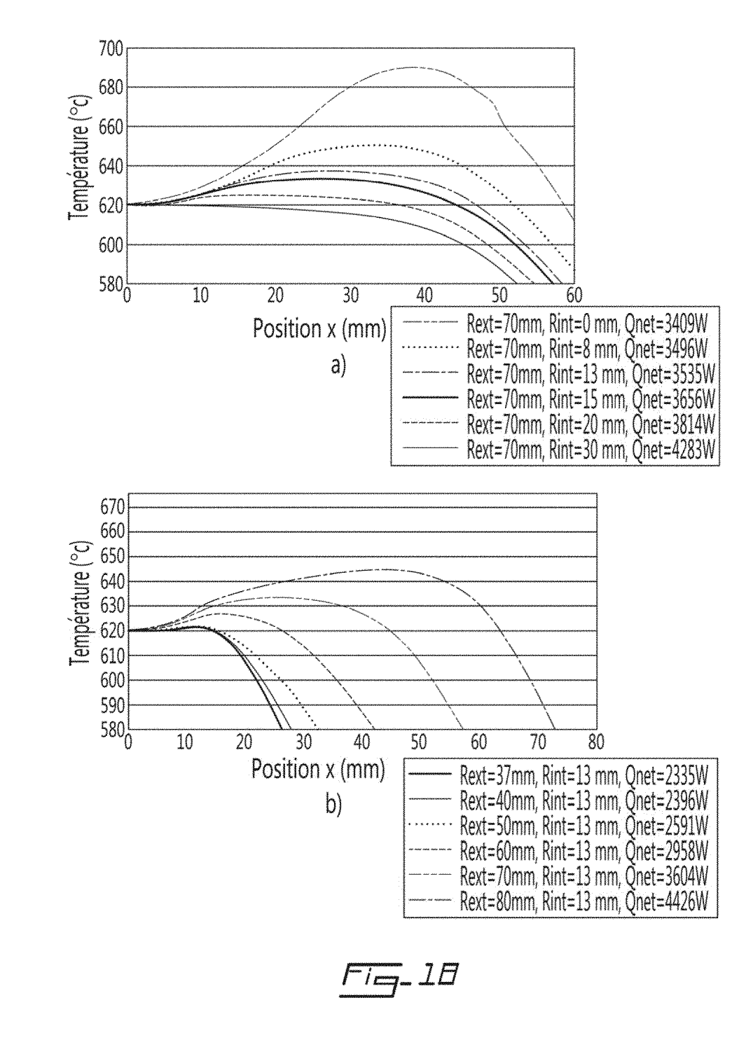

Referring to FIG. 17, a nonlinear optimization algorithm can be used to improve the parameters in steady state in 4 steps. FIG. 17 illustrates each step. Firstly, the trajectory and the heat flows are estimated so as to generate a more uniform temperature distribution as possible. The experience gained on similar geometries is used to estimate the best possible departure settings. Secondly an algorithm changes the distance between the outbound and the return to improve the lateral temperature distribution and thus expand depending on the needs the required thermal treatment. Third, the algorithm modulates the distribution of the heat flow as a function of the longitudinal position. Finally, a fourth algorithm finalizes the settings to ensure that the result respects the requirements of the thermal treatment at infinite time.

Optimization using the Steady State Temper

By using the simulation software, an algorithm determines the trajectory parameters that maximize the uniformity of the temperature profile over a given volume. There are many applications that require lengthy heating times. For long heating time, the piece reaches a state close to the steady state temperature where the distribution of the temperature in the piece no longer varies. There are two ways to calculate this said stationary state. The first step is to calculate the whole evolution of the temperature at each time step in the piece until a point where the temperature varies no more. The quickest solution is to solve a suitable and different system of equations. The solution to the steady state is then obtained by solving a single system of equations (see equation 5).

[K(Tᵢ)]{Tᵢ}={R(Tᵢ)} (5)

Considering that the majority of applications is achieved at the approach of this steady state, it is much faster to adjust system parameters to be optimal in this state and use similar parameters to uniformize the temperature profile when the temperature rises and during the transient portion of the thermal treatment. A comparative study on simple geometries showed no significant difference between this strategy and the optimization of parameters to uniformize individually each time step in the transient phase. For complex geometries, some changes are needed to get closer, during the transient portion, to the profile that is as uniform as possible.

Design of the Inductor

The coil is firstly dimensioned so as to generate a temperature profile that is as uniform as possible, and without moving the source. To do this, the internal radius (Rᵢₙₜ) is determined by the minimum bend radius allowed by the copper pipe. FIG. 18a) shows the influence of the inside radius of the temperature profile. As shown in FIG. 18b) for a fixed inner radius, the increase in the outer radius (Rₑₓₜ) degrades the uniformity of the profile. On the other hand, the larger the inductor is made and the larger is the heated zone. For highly curved geometries, the diameter may affect the maneuverability of the system and therefore the possibility to adjust the temperature profile based on imponderables.

Optimization of the Lateral Temperature Profile

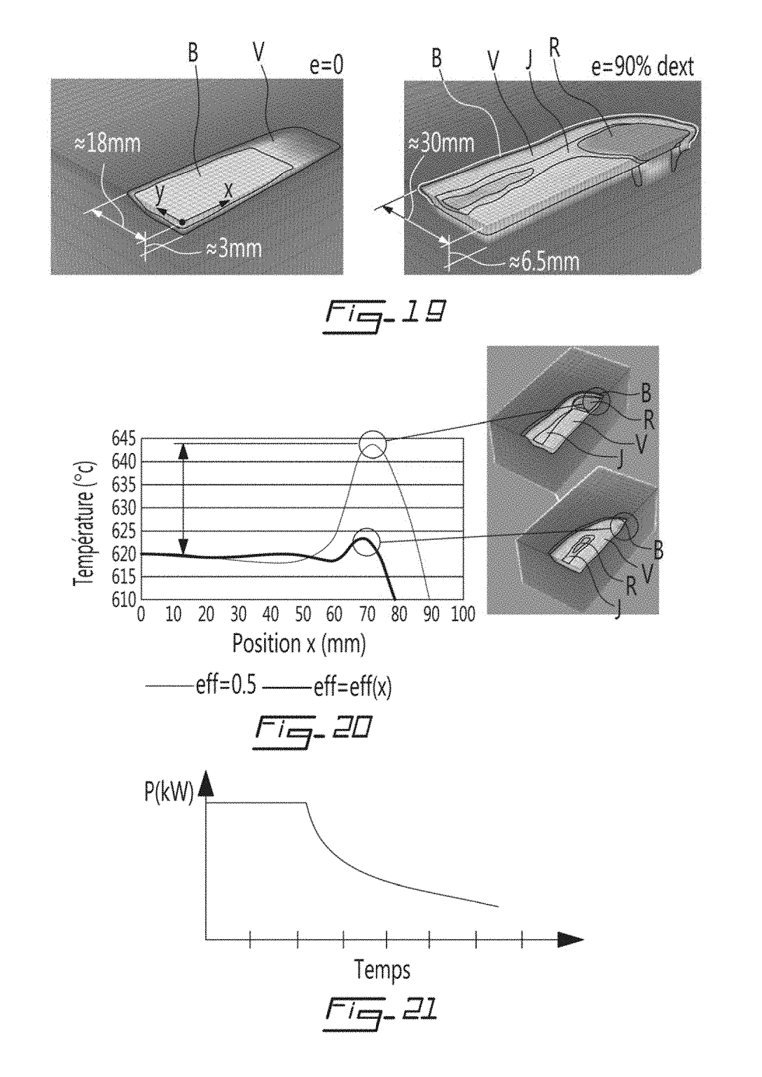

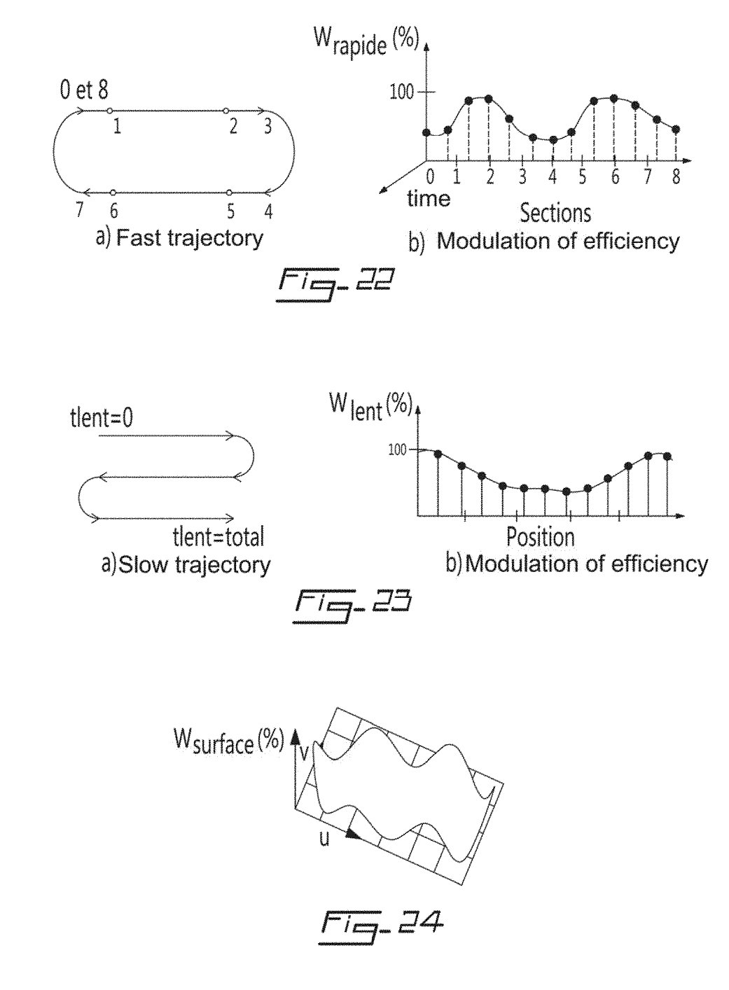

The distance between the outbound and return (the trajectory between 2 and 6 in FIG. 12) is used to amplify the width and penetration of the heated volume. This distance is, generally, selected slightly smaller than the outer diameter (≈90%). It is important to note that some situations (e.g. variable thickness, near the ends, etc.) require to alter this distance depending on the position on the trajectory 2 or trajectory 6 of FIG. 12. FIG. 19 illustrates the effect of this parameter.

In a heated piece whose dimensions are infinite, keeping the minimum inner radius, a simple scaling of the couple outside radius and distance between the outbound and return can increase both the width and penetration of the volume heating. Depending on the situation increasing the inner radius may allow to slightly increase the uniformity of the profile.

Optimization of the Longitudinal Temperature Profile

For the same trajectory, the length of the heated zone is increased by modulating the flow of heat according to the position on the cyclic trajectory. The length of the bend influences the uniformity of the profile. Depending on the length of minimum bend achievable by the operator, as shown in FIG. 20, the time taken for the manipulator to change direction can lead to overheating. Modulating the heat flow is also used to accommodate the effect of this variable. Strategically tilting the serpentine coil also improves uniformity.

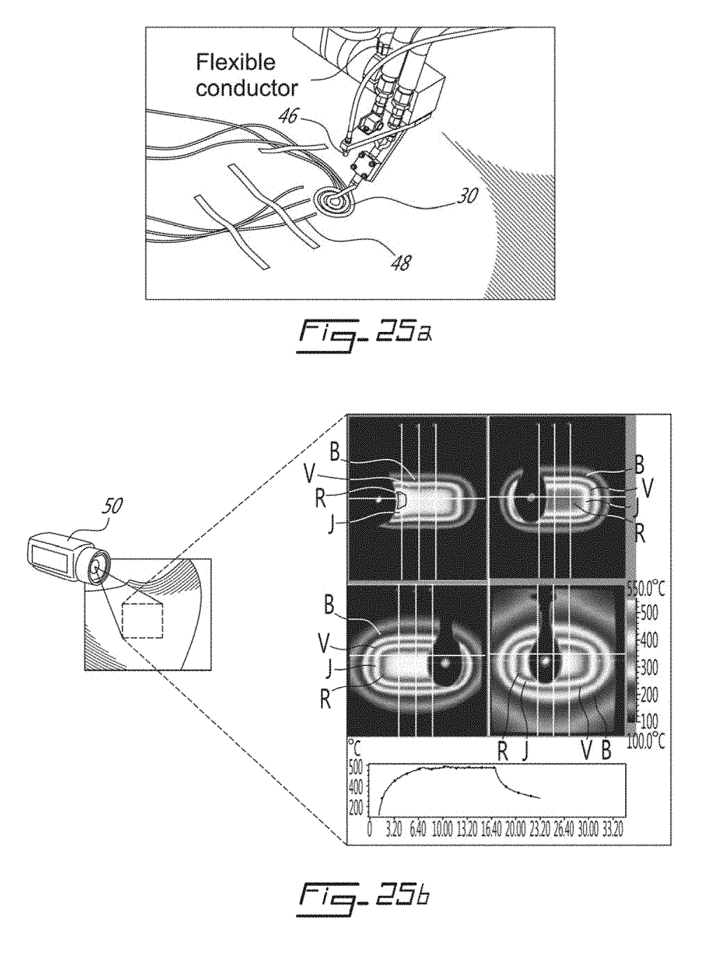

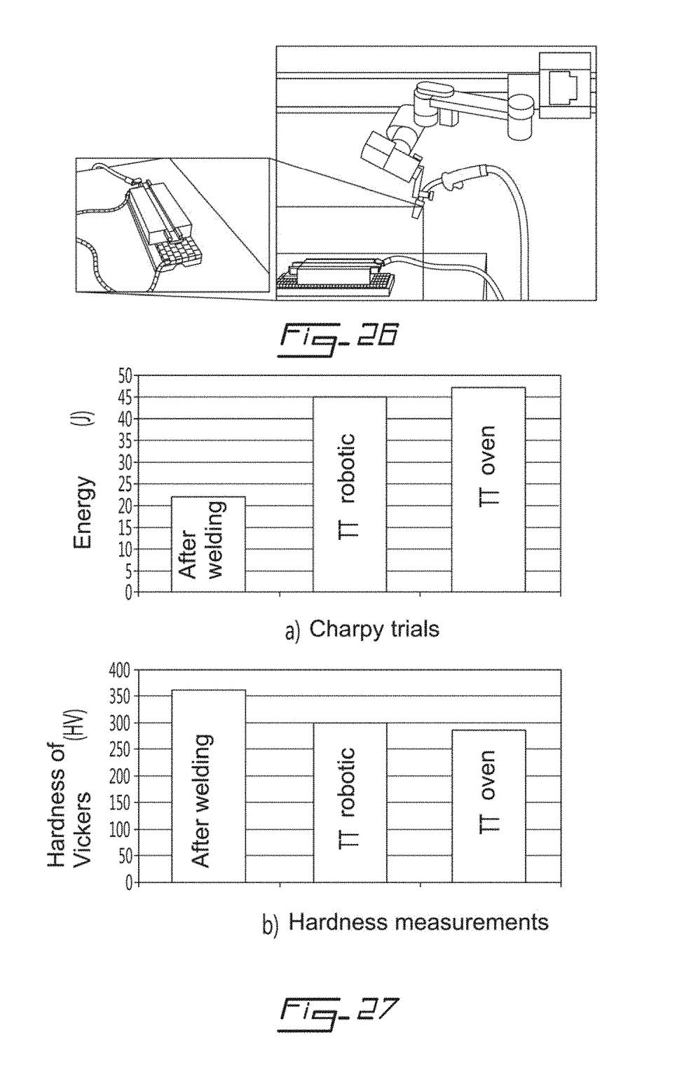

The flow of heat is injected modulated according to four complementary schemes. First, as shown in FIG. 21, the heat flow is modulated as a function of time (Wₙₒₘᵢₙₐₜₑ(kW)). Second, the nominal flow of heat is adjusted according to the position on the fast path (W_{rapide}(%)). (See FIG. 22). Some applications also require varying this heat flow distribution according to time. Third, the heat flow is also adjusted depending on the position on the slow path (Wₗₑₙₜₑ(%)) (see FIG. 23). Fourth, this heat flux can be finally adjusted as a function of position on the composite parametric surface (W_{surface}(%)) shown in FIG. 24. As shown in the following equation, the injected heat flow W is the result of multiplying the nominal flow of heat by all the factors associated with each of the modulation schemes.

W=WₙₒₘᵢₙₐₜW_{slow}W_{fast}W_{surface} (6)

The accuracy on the control of the temperature profile achieved by adequately modulating each parameter is generally greater than the accuracy of the measuring instruments (see Measuring Systems section).

High Performance Calculation System

To ensure the success of the method on location, all of the above-presented analysis should be achievable in situ. Indeed, in cases where site access is difficult or restrained, taking measurements to determine a priori the geometry of the heating volume (zone) is complex. In addition, certain operations such as thermal treatment after repair of a crack require prior operations (gouging, machining, welding, grinding, polishing or hammering) that affect the geometry of the volume to be heated.

The system therefore incorporates high performance computing technologies such as parallelization of computing on CPU and GPGPU. The assembly of matrices according to the finite element system is carried out on several microprocessors (CPU). The resolution of the matrix system is then transferred to the system using GPGPU libraries in the public domain. The conjugate gradient algorithm is used by previously applying a preconditioner to the stiffness matrix.

Measurement Systems

A measurement system can be used to ensure the quality of the temperature profile and compensate for modeling errors. The temperature profile is read with the aid of one or more pyrometers, infrared camera and thermocouples. The camera is fixed relative to the scene, the pyrometers 46 are installed on the end effector of the manipulator to read a temperature near the serpentine coil and thermocouples 48 are welded directly onto the plate. FIG. 25 shows an example of a reading taken by the thermal camera 50.

Control

Each of the measurement systems listed in the previous section can be used for the temperature control. Indeed, the additional accuracy provided by the thermocouples soldered directly on the piece is used to perform an absolute measure and to validate that the heat flux injected into the piece actually achieves the required temperature. The measurements of movable pyrometers and the thermal camera 50 are combined to validate the uniformity of the temperature profile. Algorithms based on iterative learning control principle modulate the parameters to ensure the quality of the heating profile.

Experimental validation

Temperature Distribution

Each step of development on the control of the temperature profile is first developed on simple pieces and always validated on complex geometries such as turbine wheels. The results for each of the sections show a match between the simulated and measured values with thermocouples, an infrared camera and a pyrometer.

Mechanical Properties

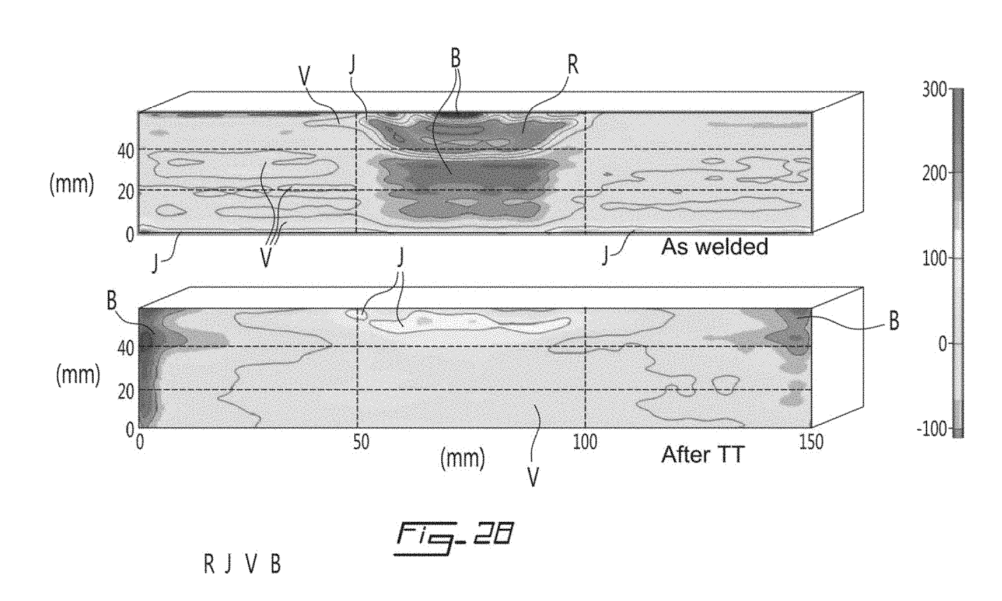

The impact of robotic thermal treatment on the mechanical properties of a weld is validated on the martensitic stainless steel plate UNS S41500 shown in FIG. 26. The entire plate is first treated to achieve the microstructural properties of steel in the base metal of a turbine wheel. To simulate a laboratory crack repair, a notch 292×149×57 mm is machined in the plate (FIG. 1b). Four layers of weld metal are deposited to fill the notch. FIG. 1c). The top layer is ground flush with the surface of the plate (FIG. 1d). Finally, the thermal treatment is carried out using the method described above for controlling the temperature between 600 and 630° C. for one hour to restore the microstructure and smoothing the internal stresses (FIG. 1f).

An objective is to compare the microstructure obtained after the completion of the robotic thermal treatment and after a conventional thermal treatment in an oven. To estimate the final properties (e.g. resistance to crack propagation), Charpy testing and hardness are carried out on the welded zone as welded and after each thermal treatment (robotic and conventional). Measurements are also performed to quantify the phase (austenitic and martensitic) that are present. A significant improvement in the properties is observed after treating the martensitic stainless steel 13Cr-4Ni between 600 and 630° C. for one hour. The results are shown in FIG. 27. The measured properties are similar, after each of the two thermal treatments (TT). The results are also consistent with the literature (see Bilmes et al. [1]).

The second objective is to significantly reduce the internal stresses after welding. The internal stresses (see FIG. 28) are measured using the method of the contours. For this specific application, the robotic thermal treatment reduces by a factor of three the stress level. These results are also consistent with the literature on heat treatments on stainless steels 13Cr-4Ni. Sabourin et al. [2] mentions that optimal conditions for heat treatment in the workshop after complete assembling a turbine wheel lowers the maximum stress of 410-130 MPa. The elastic limit of CA6NM is around 550 MPa. The details of this validation are detailed by Godin et al. [3].

Finally, the applications of this invention can be varied. We detail below some possible applications.

Turbine Blade Profiling

The arrival of new digital computing technologies now enables the development of blade profiles more effectively. The difference in efficacy between the current wheels and those of the past is marked. This difference represents a significant monetary loss for an electrical producer. To modify the profile in place by welding and grinding alters the properties of steel and generates significant internal stresses. There is therefore in this field a need for a technology that may allow to reset the properties base metal of the previous level and to relax internal stress. This need may advantageously be filled by the present invention.

Reconstruction of a Pan of a Pelton Wheel

Pelton wheels are usually installed in places where water is highly abrasive. The erosion generated on the pans by the passage of sediment can quickly degrade the geometry. This geometry change causes a loss of efficiency and premature wear of the wheel. There is therefore a need in the art for a technology that allows to reconstruct the geometry by welding and thermal treatment of the repaired area directly in a central. It has been until now forbidden to weld on the pans in CA6NM. This need may advantageously be filled by the present invention.

Pipeline

A pipeline is an assembly of several tubes welded in place to form a long pipe. There is therefore a need in this area for a technique that can be used to treat post-weld junctions or for repairs to ensure the sustainability of the facilities. This need may advantageously be filled by the present invention.

Retouch of Large Parts at the Manufacturer

The assembly of large pieces by welding is complex. Such operation frequently leads to geometrical and structural non-compliances. The repair of a new assembly, following a non-compliance, may require complex operations should require heat treatment of the entire piece. There is therefore a need in the art for a method of thermal treatment that would enable the manufacturer to locally repair the defect and to locally perform the thermal treatment associated with the repair.

Thermal Treatment of Injection Molds

The choice of steels used for the manufacture of plastic injection molds is critical. To maximize corrosion resistance and durability, the matrix must be thermally treated. Traditionally, used materials are difficult to weld and therefore are impossible to be modified or repaired. There is therefore in this field a need for a thermal treatment process that can be used to perform a localized thermal treatment following a repair or modification of a mold by welding. This need may advantageously be filled by the present invention.

The inventors believe that the reasons for the difficulty for the industry to perform a quality localized thermal treatment (TT) are:
1. The impossibility for a worker to maintain a high temperature profile within a narrow temperature range without computer simulation or feedback loop (e.g. The CA6NM requires thermal treatment (TT) between 600 and 630° C. for 1 hour).
2. The impossibility for a worker to maintain a high temperature profile within a narrow temperature range for hours.
3. The impossibility of current technologies (thermal blanket, induction coil wound around a pipeline) to locally maintain a uniform temperature profile within a significant volume on complex geometries or having variable thickness or being unsymmetrical.
4. The need for current technologies to extend the heated zone to a much greater width than the area to be treated. This is required to ensure the uniform temperature profile in the desired zone. In addition, this applies to simple pieces only. Finally, this requires large installations and increases the importance of deformations and internal stresses.
5. The inability of current technologies to adapt to in situ unforeseen situations (e.g. the geometry of the piece and the volume to repair are unexpected).
6. The difficulty installing existing technologies in tight places.

The present invention thus has several advantages over thermal processing of known types, namely:
1. Heat treatment after welding with electric blanket. Such system has the following disadvantages;
There is no control over the temperature distribution.
The system is not applicable for complex geometries.—The system is not applicable to the geometries of variable thickness.
The system is dedicated for a specific application.
The system is not sufficiently adaptable for in situ repair applications.
The system is very large for in situ applications.
2. Heat treatment in a furnace. Such system has the following disadvantages.
The piece must be dismantled and transported to the oven.

For large parts, a furnace of very large dimensions is required.
The full piece is processed.
3. Heat treatment by fixed induction. This system has the follow wing disadvantages:
The system is bulky.
The system is fixed.
The piece is brought to the heating system.
The system is dedicated to one application.

### REFERENCES

[1] P. Bilmes Llorente C and J Perez Ipiña 2000 Toughness and Microstructure of 13Cr4NiMo high-strength steel welds Journal of Material Engineering and Flight Performance 9 No. 6 pp 609-615.
[2] M Sabourin, Thibault D, A and D Bouffard Lévesque M 2010 New parameters influencant hydraulic runner lifetime 2010 25th IAHR Symposium on Hydraulic Machinery and Systems (Timisoara, Romania).
[3] Godin S, E Boudreault, Lévesque J-B and Hazel B 2013 post-weld heat treatment On-Site of welds made of Steel 410NiMo Proceedings of MS & T-COM (Montreal, Quebec, Canada),
[4] Fisk, M., Lundbäck, A., 2012, “Simulation and validation of repair welding and heat treatment of an alloy 718 plate”, Finite Elements in Analysis and Design, Vol. 58.”
[5] Ruffini, R. T., Nemkov, V., 2004, “New Magnetodielectric Materials for Magnetic Flux Control”, HES 2004.

The claims should not be limited in scope by the preferred embodiments illustrated in the examples, but should receive the broadest interpretation that conforms to the specification as a whole.

In the figures, the areas identified by the letters A, J, G and B correspond to red, yellow, green and blue on the original figures and each represent a temperature range higher temperatures in red, moderately high temperatures in yellow, moderately low temperatures in green and the lowest temperatures in blue.

1. Method for induction heat treatment on a targeted zone of a metal piece, the method comprising: performing the heat treatment on the targeted zone using a thermal element mounted on a robotic system for displacing the thermal element by following a cyclical trajectory on the targeted zone so as to heat the targeted zone and to minimize temperature deviations on the targeted zone.

2. The method according to claim 1, wherein the thermal element comprises an induction coil or serpentine coil.

3. The method according to claim 2, wherein the induction coil or serpentine coil comprises a magnetic flux concentrator.

4. The method according to claim 1, wherein the robotic system comprises a robotic arm for moving the thermal element on the cyclical trajectory.

5. The method according to claim 2, comprising feeding the thermal element with electrical power by means of a parallel resonant circuit.

6. The method according to claim 5, wherein the parallel resonant circuit comprises an inverter connected to a power source via a rectifier and a capacitor connected to the inverter by an RF cable, the capacitor being connected to the induction coil or to the serpentine coil by a flexible cable.

7. The method according to claim 6, wherein the capacitor is mounted on the robotic arm.

8. The method according to claim 1, comprising measuring a temperature profile of the targeted zone in order to control the temperature of the targeted zone.

9. The method according to claim 8, wherein the temperature profile of the targeted zone is measured using at least one element selected from: a thermocouple, a pyrometer mounted on the thermal element and an infrared camera.

10. The method according to claim 1, comprising performing a modeling of a mean heat flux per unit surface area fᵢ(x, y, z) injected into the targeted zone in order to simulate the actual temperature on the piece, the mean heat flux per unit surface area fᵢ(x, y, z) injected into an element i on a cycle of the trajectory being calculated according to the equation:
$${f}_{i} ( x , y , z ) = \frac{Q}{A} \frac{{t}_{i} ( x , y , z )}{{t}_{cycle}}$$
where Q is a heat flux of a source, A is an area of the projected source on the targeted zone, and tᵢ(x, y, z) t_{cycle} is the proportion of the time taken by the source to complete a cycle (t_{cycle}) that the source passes to heat a coordinate tᵢ(x, z)).

11. The method according to claim 1, comprising performing a modeling of a mean heat flux per unit surface area fᵢ(x, y, z) injected into the targeted zone in order to simulate the actual temperature on the piece, the mean heat flux per unit surface area fᵢ(x, y, z) injected into an element i on one revolution/cycle of the trajectory being calculated according to the equation:
$${f}_{i} ( x , y , z ) = \frac{{\int }_{0}^{{t}_{cycle}} {f}_{i} ( x , y , z , t ) dt}{{t}_{cycle}}$$
where fᵢ(x, y, z, t) is the heat flux per unit area injected into the target zone in time t and t_{cycle} is the time taken by the source to complete one revolution/cycle.

12. The method according to claim 1, wherein the cyclical trajectory comprises: a) a first cyclic trajectory component (tᵣₐₚ) that is followed by the thermal element at a first average velocity over a portion of the targeted zone; and b) a second trajectory component (tₗₑₙₜ) that is followed by the thermal element at a second average speed lower than the first average speed.

13. The method according to claim 1, comprising:
a) uniformizing a temperature profile (T) in steady state around the targeted zone by means of a simulator;
b) recovering a shape of the cyclic trajectory generated by the simulator in steady state;
c) modulating a heat flux injected into the thermal element as a function of time and of the position of the thermal element on the cyclic trajectory so as to minimize the temperature deviations on a given zone during a temperature rise phase and/or during the heat treatment and to maintain the temperature constant during the heat treatment.

14. Method for repairing a metal piece having a damage on a targeted zone, comprising:
a) gouging and/or machining around the damage;
b) welding after said gouging and/or machining;
c) grinding and/or polishing after said welding;
d) performing the induction heat treatment method according to claim 1, following said grinding and/or polishing using a thermal element mounted on a robotic system for moving the thermal element by following a cyclical trajectory on the targeted zone so as to heat the targeted zone and to minimize the temperature deviations on the targeted zone.

15. System for heat treatment on a targeted zone of a metal piece, comprising a thermal element mounted on a robotic system for displacing the thermal element by following a cyclical trajectory on the targeted zone so as to heat the targeted zone and to minimize temperature deviations on the targeted zone.

16. The system according to claim 1 wherein the thermal element comprises an induction coil or serpentine coil.

17. The system according to claim 16, wherein the induction coil or serpentine coil comprises a magnetic flux concentrator.

18. The system according to claim 15, wherein the robotic system comprises a robotic arm for moving the thermal element on the cyclical trajectory.

19. The system according to claim 16, comprising a parallel resonant circuit for feeding the thermal element with electrical power.

20. The system according to claim 19, wherein the parallel resonant circuit comprises an inverter connected to a power source via a rectifier and a capacitor connected to the inverter by an RF cable, the capacitor being connected to the induction coil or to the serpentine coil by a flexible cable.

21. The system according to claim 20, wherein the capacitor is mounted on the robotic arm.

22. The system according to claim 15, comprising a thermal system for measuring a temperature profile of the targeted zone in order to control the temperature of the targeted zone.

23. The system according to claim 22, wherein the thermal system comprises thermocouple(s), pyrometer(s) mounted on the thermal element and infrared camera(s).

24. The system according to claim 15, comprising a simulator configured for:
a) uniformizing a temperature profile (T) in steady state around the targeted zone;
b) recovering a shape of the cyclic trajectory generated by the simulator in steady state;
c) modulating a heat flux injected into the thermal element as a function of time and of the position of the thermal element on the cyclic trajectory;
wherein the system comprises a controller for modulating the trajectory and the heat flux injected into the thermal element as a function of time and of the position of the thermal element on the cyclic trajectory so as to minimize the temperature deviations on a given zone during a temperature rise phase and/or during the heat treatment and to maintain the temperature constant during the heat treatment.

25. The system according to claim 24, wherein the simulator is configured for modeling of a mean heat flux per unit surface area fᵢ(x, y, z) injected into the targeted zone in order to simulate the actual temperature on the piece, the mean heat flux per unit surface area fᵢ(x, y, z) injected into an element i on a cycle of the trajectory being calculated according to the equation:
$${f}_{i} ( x , y , z ) = \frac{Q}{A} \frac{{t}_{i} ( x , y , z )}{{t}_{cycle}}$$
where Q is the heat flux of a source, A is the area of the projected source on the targeted zone, and tᵢ(x, y, z)/t_{cycle} is the proportion of the time taken by the source to complete a cycle (t_{cycle}) that the source passes to heat a coordinate (tᵢ(x, y, z)).

26. The method according to claim 24, wherein the simulator is configured for modeling of a mean heat flux per unit surface area fᵢ(x, y, z) injected into the targeted zone in order to simulate the actual temperature on the piece, the mean heat flux per unit surface area fᵢ(x, y, z) injected into an element i on one revolution i cycle of the trajectory being calculated according to the equation:
$${f}_{i} ( x , y , z ) = \frac{{\int }_{0}^{{t}_{cycle}} {f}_{i} ( x , y , z , t ) dt}{{t}_{cycle}}$$
where fᵢ(x, y, z, t) is the heat flux per unit area injected into the target zone in time t and t_{cycle} is the time taken by the source to complete one revolution/cycle.
